(19) United States
(12) Patent Application Publication
(10) Pub. No.: US 2011/0065860 A1
(43) Pub. Date: Mar. 17, 2011

(54) METHOD FOR PREPARING A BLEND OF HALOGENATED POLYMER AND OF COPOLYMER BEARING ASSOCIATIVE GROUPS

(75) Inventors: Manuel Hidalgo, Brignais (FR); Thierry Pascal, Charly (FR)

(73) Assignee: ARKEMA FRANCE, Colombes (FR)

(21) Appl. No.: 12/991,220

(22) PCT Filed: May 5, 2009
(86) PCT No.: PCT/FR09/50827

§ 371 Date: Nov. 5, 2010

(30) Foreign Application Priority Data
May 7, 2008 (FR) 08 53030

(51) Int. Cl. C08L 27/06; C08F 114/06

(52) U.S. Cl. 524/569; 526/344.2

(57) ABSTRACT

The present invention relates to a method of preparing a polymer resin based on a halogenated vinyl polymer and a copolymer bearing associative groups, comprising the steps that consist in forming a latex of each of these polymers, blending said latices, then isolating and drying the polymers contained in said latices in order to form a pulverulent resin. The present invention also relates to said resin, to a pulverulent composition containing said resin, and also to the use of this composition for manufacturing rigid or plasticized materials.

The present invention relates to a method for preparing a pulverulent resin based on a halogenated vinyl polymer and a copolymer bearing associative groups. It also relates to said resin, to a composition containing said resin, and also to the use of this composition for manufacturing rigid or plasticized materials.

“Supramolecular” materials are materials made up of compounds associated by noncovalent bonds, such as hydrogen, ionic and/or hydrophobic bonds. They can in particular be polymers onto which are grafted associative groups capable of bonding together via cooperative hydrogen bonds. One advantage of these materials is that these physical bonds are reversible, in particular under the influence of temperature or through the action of a selective solvent. The easy use and/or the properties of polymers, for instance the mechanical, rheological, thermal, optical, chemical and physicochemical properties, can therefore be improved by the grafting of these associative groups. The latter can also confer the properties of high-molecular-weight polymers on low-molecular-weight polymers, which are easier to prepare in a controlled manner.

Document WO 2006/016041 thus discloses polymers grafted with associative groups which make it possible to confer, on said polymers, a higher elastic modulus and better resistance to solvents.

For its part document U.S. Pat. No. 2,980,652 discloses copolymers containing associative groups of imidazolidone type, which have a good ability to adhere to substrates, in particular metal substrates, and which are useful in particular for manufacturing water-based paints.

Example 9 discloses more particularly the product of reacting UDETA with a maleic anhydride/methyl methacrylate copolymer. This product is formulated in a lacquer which may be sprayed onto steel panels (Examples 14 and 15).

In this context, the applicant focused on the means for modifying halogenated vinyl polymers such as PVC with a view to making them supramolecular materials and thus improving their properties. Various trials were consequently undertaken with the aim of grafting imidazolidone associative groups onto PVC by reacting the latter with N-aminoethyl-2-imidazolidone (UDETA).

However, it was apparent to the applicants that the nucleophilic attack by the UDETA on the PVC led to a degradation of the latter owing to dehydrochlorination, with concomitant formation of hydrochloric acid, which made the direct grafting of UDETA in bulk (without solvent) onto PVC in instruments for transforming PVC, such as calenders, extruders or presses, impossible.

In order to bypass this problem, other pathways were envisioned, which all, however, have major drawbacks.

This is true of grafting via the solvent process which, although it allows the operating conditions (concentration of PVC and UDETA, choice of solvent, temperature) to be adjusted in order to promote substitution of the PVC with the UDETA at the expense of its degradation, requires the use of large amounts of solvent.

In addition, although it represents an advantageous alternative, copolymerization of vinyl chloride monomer with methacrylic monomers carrying associative groups of imidazolidone type would come up against the difficulty of obtaining copolymers with a homogeneous composition, given the considerable difference in the ratios of reactivity of methacrylic and acrylic monomers in general, with vinyl chloride monomer (VCM) (see J. Bandrup et al., Polymer Handbook, 3^{rd} Edition, John Wiley).

Finally, the grafting of associative groups onto a PVC via functions other than the amine function of the UDETA, such as the mercaptan function, also does not offer a satisfactory solution since the synthesis of molecules carrying both associative functions of imidazolidone type and grafting units other than amine, such as mercaptan functions, adds steps to the method for obtaining grafted PVCs.

It is to the applicant's credit to have developed a method which makes it possible to result in a PVC-based material of supramolecular type, having improved properties while at the same time overcoming the abovementioned drawbacks. To achieve this objective, the applicant imagined an “indirect modification” of a halogenated vinyl polymer such as PVC, by blending, on the nanometric scale, with a copolymer rich in monomers which, after polymerization, give blends which are compatible with PVC and which bear, moreover, given associative groups. It is thus possible to obtain a highly compatible homogeneous blend of polymers and to indirectly convey certain associative groups into PVC with a view to conferring various properties thereon.

More specifically, it has been demonstrated that the polymer bearing associative groups according to the invention makes it possible to confer properties of strong adhesion to metals and of improved creep resistance on the halogenated vinyl polymer such as PVC and can optionally also give it improved rheological, mechanical or thermal properties, in particular a greater elongation at break, improved thermal stability, a higher softening point and greater strength of the melt at low shear rate.

It is, admittedly, already known from FR 2 891 548 that the adhesion of poly(vinylidene chloride) or PVDC to metal or polymer surfaces can be improved by blending it with a copolymer containing monomers, in particular acrylic monomers, bearing phosphonate groups and other monomers, in particular acrylic monomers. However, it is not suggested in this document that the use of a copolymer bearing associative groups of nitrogenous heterocycle type could make it possible to improve several properties of halogenated vinyl polymers such as PVDF.

The subject of the present invention is precisely a method for preparing a polymer resin, comprising the successive steps consisting in:

1—forming a first latex from at least one halogenated vinyl polymer and a second latex from at least one copolymer containing, firstly, units derived from a first monomer (A) making said copolymer compatible with said halogenated vinyl polymer and, secondly, units derived from a second monomer (B) bearing at least one associative group chosen from imidazolidonyl, triazolyl, triazinyl, bisureyl and ureidopyrimidyl groups, preferably an imidazolidonyl group,

2—blending said latices, and

3—isolating and drying the polymers contained in said latices in order to form a pulverulent resin.

The subject of the present invention is also the resin which can be obtained according to this method.

The various steps of the method according to the invention will now be described in greater detail. It is clearly understood that this method can comprise steps other than those mentioned above, in particular one or more preliminary, subsequent and/or intermediate steps, as long as the sequence of steps mentioned above is respected.

Formation of the Latices

The first step of the method according to the invention comprises the formation of a latex, firstly, of a copolymer bearing given associative groups and, secondly, of a halogenated vinyl polymer.

The copolymer bearing associative groups contains specifically, firstly, units of a first monomer (A) making said copolymer compatible with said halogenated vinyl polymer and, secondly, units of a second monomer (B) different than the unit (A) and bearing one or more associative groups according to the invention. The monomer (A) preferably represents at least 20 mol %, and advantageously at most 80 mol %, of the copolymer.

The term “compatible” is intended to mean that the halogenated vinyl polymer and the copolymer exhibit partial or total miscibility. Depending on the nature of the copolymer and in particular of the monomer (A) used to synthesize said copolymer, the compatibility within the meaning of the invention, with the halogenated vinyl polymer, can be obtained in varying proportions of the blend of the two polymers. This compatibility can be demonstrated by physical miscibility measurements.

This total or partial miscibility can be detected by various analytical methods known to those skilled in the art, such as scanning electron microscopy (SEM) or transmission electron microscopy (TEM) or alternatively atomic force microscopy (AFM), often making it possible to detect inhomogeneities of the blends in the form of domains of characteristic size greater than 1 micron (immiscibility), and also by measurements of glass transition temperature, Tg, of the blend of the two polymers. Total miscibility results in the existence of a single Tg for the blend, and partial miscibility results in the existence of two Tgs, at least one of which is different than the Tg of the halogenated vinyl polymer and than the Tg of the copolymer. The methods for measuring the Tg of polymers and polymer blends are known to those skilled in the art and include differential scanning calorimetry (DSC), volumetric analysis or dynamic mechanical analysis (DMA).

Thus, any copolymer bearing associative groups according to the invention and compatible, within the meaning explained above, with the halogenated vinyl polymer can be used according to the invention, in particular any copolymer based on a monomer (A) of which the corresponding homopolymer is known to be miscible with the halogenated vinyl polymer or for which the presence of units derived from the monomer (A) leads to compatibility with the halogenated vinyl polymer. As nonexclusive examples of monomers (A), mention may be made of (meth)acrylic monomers, such as methyl methacrylate, polyethylene glycol methacrylate, methoxy polyethylene glycol methacrylate and acrylonitrile, or else maleic anhydride. As examples of copolymers bearing associative groups that can be blended, in varying proportions according to their nature and that of the halogenated vinyl polymer, with the halogenated vinyl polymer in order to obtain the compatibility and the effects of “indirect modification” via reversible physical bonds according to the invention, mention may be made of copolymers of methyl methacrylate (termed PMMA copolymers) bearing associative groups, copolymers of monomers comprising a polyethylene glycol side chain (termed copolymers comprising a PEG side chain) bearing these associative groups, copolymers of maleic anhydride bearing these associative groups or copolymers of acrylonitrile bearing these associative groups.

The term “associative groups” is intended to mean groups capable of associating with one another via hydrogen bonds, advantageously via 1 to 6 hydrogen bonds. The associative groups that can be used according to the invention are more specifically imidazolidonyl, triazolyl, triazinyl, bisureyl and ureidopyrimidyl groups, imidazolidonyl groups being preferred.

According to one preferred embodiment of the invention, the associative groups are introduced during the formation of the copolymer. The copolymer is thus capable of being obtained by copolymerization of the monomer (A) with a monomer (B) which bears the associative groups and, optionally, one or more other monomers, preferably starting from:
firstly, a monomer (A) which is a (meth)acrylic monomer chosen from: methyl methacrylate, (methoxy) polyethylene glycol (meth)acrylate and acrylonitrile; or maleic anhydride,
secondly, a monomer (B) bearing associative groups, preferably imidazolidonyl groups, which is advantageously chosen from: ethylimidazolidone methacrylate (or MEIO) and ethylimidazolidone methacrylamide (or WAM II), and
optionally, one or more other monomers chosen from acrylic or methacrylic acids, esters thereof, amides thereof and salts thereof, itaconic acid, esters thereof, amides thereof or salts thereof, and styrene and derivatives thereof such as 4-styrene sulfonate.

Such a copolymer can be prepared in the form of a latex according to methods of free-radical polymerization in a disperse medium, for example in an aqueous emulsion. These methods are well known to those skilled in the art and are described in general and specialized books, for instance in Chapter 7 of the book “Les latex synthétiques: Elaboration, Propriétés, Applications” [Synthetic latices: production, properties, applications], coordinated by C. Pichot et J. C. Daniel (published by TEC&DOC de Lavoisier, France, 2006).

These methods use water-soluble free-radical polymerization initiators. Various mechanisms for generating radicals can be used, for instance thermal decomposition, oxidation-reduction reactions, decomposition caused by electromagnetic radiation, and in particular radiation in the ultraviolet range. Nonexclusive examples of water-soluble initiators include hydroperoxides, for instance tert-butyl hydroperoxide, water-soluble azo compounds such as 2,2′-azobis(2-amidinopropane)dihydrochloride and organic or inorganic salts of 4,4′-azobis(4-cyanovaleric) acid, inorganic oxidizing agents such as sodium persulfate, potassium persulfate or ammonium persulfate, aqueous hydrogen peroxide solution, perchlorates, percarbonates and ferric salts. These oxidizing agents can be used alone or in combination with inorganic or organic reducing agents such as sodium bisulfite, sodium metabisulfite, potassium bisulfite, potassium metabisulfite, vitamin C (ascorbic acid), sodium hypophosphite or potassium hypophosphite. These organic or inorganic reducing agents can also be used alone, i.e. in the absence of inorganic oxidizing agents. The initiators soluble in the aqueous phase are used, in the case of the emulsion polymerizations, in proportions ranging from 0.01% to 10% by weight, relative to the total weight of the monomers.

In addition to the polymerization initiators, it may prove to be useful to dissolve, in the monomers to be copolymerized, other additives, among which mention may be made of chain transfer agents, which make it possible to reduce the molecular masses. By way of examples of chain transfer agents, mention may be made of alkyl mercaptans, for instance methyl mercaptan, ethyl mercaptan, n-propyl mercaptan, isopropyl mercaptan, n-butyl mercaptan, tert-butyl mercaptan, cyclohexyl mercaptan, benzyl mercaptan, n-octyl mercaptan, tert-nonyl mercaptan, n-dodecyl mercaptan or tert-dodecyl mercaptan, and alkyl thioglycolates, for instance methyl thioglycolate, ethyl thioglycolate, 2-ethylhexyl thioglycolate or isooctyl thioglycolate. The chain transfer agents are generally used in proportions of between 0.01% and 10%, and preferably between 0.5% and 2% by weight, relative to the total weight of the monomers.

It is also possible to dissolve, in the monomers to be copolymerized, other additives such as antioxidants, for instance butylhydroxytoluene (BHT), biocides and/or polymerization initiator activators. These additives are generally used in proportions of between 0.01% and 5% by weight, relative to the total weight of the monomers.

In addition, surfactants or stabilizers which make it possible to constitute the starting emulsions and to stabilize the final latices obtained can be used. Three families of surfactants or stabilizers can be considered, namely:

1) surfactant molecules of natural or synthetic origin having a dispersing and stabilizing effect by electrostatic repulsion and comprising positively or negatively charged amphiphilic molecules, or forming zwitterions (amphoteric molecules), in an aqueous phase, among which mention may be made, by way of nonlimiting examples of: sodium or potassium alkyl sulfates or sulfonates, in particular sodium dodecyl sulfate, sodium or potassium alkyl aryl sulfates or sulfonates, in particular sodium dodecyl benzene sulfonate, potassium, sodium or ammonium salts of fatty acids, in particular sodium stearate, alkylated and disulfonated diphenyl oxides, in particular the commercial surfactants of the Dowfax® range, for instance Dowfax® 2A1, sulfosuccinates, and in particular the commercial surfactants of the Aerosol® range, for instance Aerosol® MA 80 which is sodium dihexyl sulfosuccinate or Aerosol® OT-75 which is sodium dioctyl sulfosuccinate, phosphoric esters, fatty amines, polyamines and salts thereof, quaternary ammonium salts, for instance ammonium alkyl trimethyl chlorides or bromides, betaines, for instance N-alkylbetaines or sulfobetaines, imidazoline carboxylates, and also the ethoxylated derivatives of all these compounds;

2) uncharged or nonionic surfactant molecules having a dispersing and stabilizing effect by steric repulsion, among which mention may be made, by way of nonexclusive examples, of: ethoxylated alkyl phenols, ethoxylated fatty alcohols, block copolymers of poly(ethylene oxide) and of poly(propylene oxide), for instance, those of the Pluronic® range, fatty acid esters, alkyl polyglycosides;

3) charged or uncharged, amphiphilic or completely hydrophilic polymeric molecules, among which mention may be made, by way of nonexclusive examples, of: water-soluble polymers of natural or synthetic origin, such as polymers and copolymers of (meth)acrylic acid and their salts, polymers and copolymers of acrylamide and its derivatives, polymers based on vinyl alcohol and vinyl acetate, hydroxyethylcellulose and hydrophobically modified hydroxyethylcellulose, polyvinylcaprolactam, and polyvinylpyrrolidone.

These dispersants or stabilizers are generally present in an amount of from 0.1% to 10% by weight, relative to the total weight of monomers. It is also possible to carry out the emulsion polymerization in the absence of surfactants or stabilizing or dispersing agents; in this particular case, the final proportions of polymer, expressed as final solids content or final dry extract, i.e. after evaporation of the volatile compounds, and in particular of the water, are less than 30% by weight, relative to the total weight of the latex derived from the emulsion polymerization.

The aqueous emulsion polymerization can be carried out at atmospheric pressure or under pressure and at polymerization temperatures of between 5° C. and 180° C. Preferably, the copolymer is obtained at atmospheric pressure and at polymerization temperatures of between 50 and 95° C. The final concentrations or concentrations after polymerization of the copolymer and of the other nonvolatile components are between 1% and 75%, and preferably between 15% and 50% by weight, expressed as final dry extract or solids content, relative to the total weight of the emulsion (latex).

The method for synthesizing the copolymer can be continuous or batchwise or else of semicontinuous type, i.e. with metered additions of components, for instance metered additions of monomers, as they are or preemulsified, or metered additions of additives such as dispersants or stabilizers, initiators or other additives.

The average diameter of the particles of copolymer bearing associative groups obtained by aqueous-emulsion free-radical polymerization is generally less than 300 nm measured by diffraction and scattering particle sizing using, for example, a Mastersizer 2000® instrument from the company Malvern or using a sedimentometer.

For its part, the halogenated vinyl polymer may in particular be a fluorinated and/or chlorinated homopolymer or copolymer. It is generally a thermoplastic polymer.

A preferred example of a chlorinated polymer is poly(vinyl chloride) or PVC. Such a polymer is in particular sold by the company Arkema under the trade name Lacovyl®. Other chlorinated polymers that can be used in this invention are copolymers of vinyl chloride with monomers such as acrylonitrile, ethylene, propylene, vinyl acetate, and also poly(vinylidene chloride) or acrylic derivatives. It is also possible for the chlorinated polymer according to the invention to be a blend including at least two of the above chlorinated polymers or copolymers. In the case of the vinyl chloride copolymers, it is preferable for the proportion of vinyl chloride units to be greater than 25% and advantageously at most 99% of the total weight of the copolymer.

As fluorinated polymers, mention may in particular be made of those comprising one or more monomers of formula (I):

CFX═CHX′ (1)

where X and X′ independently denote a hydrogen or halogen (in particular. fluorine or chlorine) atom or a perhalogenated (in particular perfluorinated) alkyl radical. It is in particular preferred that X═F and X′═H.

As examples of fluorinated polymers, mention may in particular be made of:
poly(vinylidene fluoride) (PVDF),
copolymers of vinylidene fluoride with, for example, hexafluoropropylene (HFP), chlorotrifluoroethylene (CTFE), hexafluoropropylene (HFP), trifluoroethylene (VF3) or tetrafluoroethylene (TFE),
homopolymers and copolymers of trifluoroethylene (VF3),
fluoroethylene/propylene (FEP) copolymers,
copolymers of ethylene with fluoroethylene/propylene (FEP), tetrafluoroethylene (TFE), perfluoromethylvinyl ether (PFMVE), chlorotrifluoroethylene (CTFE) or hexafluoropropylene (HFP), and
blends thereof,
   some of these polymers being in particular sold by the company Arkema under the trade name Kynar®.

PVDF and PVC are preferred for use in the present invention.

The halogenated vinyl polymer can be obtained according to aqueous-microsuspension or aqueous-emulsion polymerization processes, well known to those skilled in the art.

The aqueous-emulsion polymerization can thus be carried out using a water-soluble polymerization initiator such as a persulfate, in particular potassium. persulfate, combined with an emulsifier such as sodium lauryl sulfate or sodium dodecyl benzene sulfonate and/or with stabilizing polymers and, optionally, with inorganic or organic reducing agents such as sodium formaldehyde sulfoxylate. Examples of such compounds have been described previously. The average diameter of the particles of halogenated vinyl polymer thus obtained is generally less than 500 nm, as measured by diffraction and scattering particle sizing using, for example, a Mastersizer 2000® instrument from the company Malvern or using a sedimentometer.

The aqueous-microsuspension polymerization may be of seeded type and carried out as described in particular in application FR 2 752 844, i.e. according to a process of polymerization of vinyl chloride in the presence:
of a vinyl chloride-based first seed polymer (21), prepared as described, for example, in application FR 2 309 569, the particles of which can have an average diameter of between 0.6 and 0.9 μm and contain at least one organosoluble initiator such as an organic peroxide,
of a vinyl chloride-based second seed polymer (P2), which can also be prepared as described in application FR 2 309 569 and the particles of which have an average diameter less than that of the particles of the first seed polymer (P1) and, for example, between 0.1 and 0:14 μm,
of water,
of an anionic emulsifier,
of a soluble metal salt, in particular a copper salt,
of a reducing agent such as ascorbic acid,
optionally, of a water-soluble initiator such as ammonium persulfate.

The average diameter of the particles of halogenated vinyl polymer thus obtained is generally less than 2000 nm, as measured by diffraction and scattering particle sizing using, for example, a Mastersizer 20000 instrument from the company Malvern or using a sedimentometer.

According to the invention, the halogenated vinyl polymer is preferably prepared by aqueous-emulsion polymerization.

Blending of the Latices

In the second step of the method according to the invention, the latices of, on the one hand, halogenated vinyl polymer and, on the other hand, of copolymer bearing associative groups according to the invention can be blended by any means known to those skilled in the art, for example in a tank equipped with a stirring means, or continuously in a static blender.

It is preferred that, before or after blending, each of the latices be diluted by adding water, to a dry extract content ranging from 10% to 40%, preferably from 15% to 25%.

In addition, the latices are preferably blended in a ratio of the halogenated vinyl polymer to the copolymer bearing associative groups which ranges from 1:200 to 100:1, more preferably from 1:100 to 1:1 (with respect to dry matter).

Formation and Drying of the Pulverulent Resin

In the third step of the method according to the invention, after blending and, optionally, filtering, the latices previously obtained are subjected to any method for the polymers in the form of particles from this blend. This method can either comprise, or be followed by, a drying step.

Examples of such methods include spray drying coagulation and freeze-drying.

Spray drying consists in injecting the latex blend, generally by means of spray nozzles, into a stream of hot air, which has the effect of transforming the latices into droplets of polymers and of drying them. More specifically, the blend is atomized using a conventional spray dryer known to those skilled in the art, such as a Production Minor® instrument from the company Niro, generally choosing an air inlet temperature of between 300 and 120° C. and a flow rate such that the air outlet temperature and the temperature of the spray-dried product are between 100° C. and 50° C.

For its part, the coagulation of polymer latices is generally carried out by mixing them, with appropriate stirring, with a coagulating agent based on a divalent or trivalent metal salt, such as calcium, aluminum, iron, magnesium, strontium, barium, tin or zinc chlorides, sulfates, nitrates or acetates. Other types of coagulating agents can be used, such as ammonium carbonate, organic compounds of the methyl isobutyl carbinol type (described, for example, in patent application GB659722) or dioctyl phthalate type (described, for example, in patent application JP7268021), or else cationic or anionic polymers (described, for example, in patent application FR 2373564).

The amount of coagulating agent employed is usually between 100 and 50 000 ppm, and preferably between 500 and 6000 ppm. In addition to the coagulating agent, a coagulation additive, such as a modified polyamine, can be added so as to facilitate the filtration and to increase the solids content in the coagulated product after filtration. Moreover, the pH of the medium can be adjusted to a value of between 2 and 7 by introducing a dilute acid, such as hydrochloric acid or sulfuric acid, so as to make it possible to obtain a coagulate in the form of friable aggregates, which can more readily be filtered.

The coagulation of the latices can also be obtained by addition, with appropriate stirring, of a strong inorganic acid, such as hydrochloric acid or sulfuric acid, with or without the introduction of a coagulating agent as described above, the amounts of acid being fixed so as to obtain a pH close to 1. A method of the above type is described in patent application GB1233144.

Other coagulation technologies can be used. They implement either heating of the latices with vigorous stirring by means of vapor injection, with or without the addition of a coagulating agent, as described in patent application DE954920, or specific stirring systems with a very high mechanical shear, such as turbine coagulators optionally requiring the use of a coagulating agent (as described in patent application JP4106106), or freezing of the latex in a thin layer according to a continuous process, as described in patent application FR2531716.

A pulverulent resin containing an intimate blend of the halogenated vinyl polymer and of the copolymer bearing associative groups is thus obtained according to one or other of these methods.

When this blend has been dried by spray drying, a powder of which the particle size is between 10 and 150 μm is generally obtained. When this blend has been dried by coagulation, a powder of which the particle size is between 10 and 300 μm is generally obtained.

The particle size of the powder is measured by diffraction and scattering using, for example, a Mastersizer 2000® instrument from the company Malvern or using a sedimentometer.

The subject of the invention is also composition containing the pulverulent resin described above, optionally in ground form.

This composition may in particular be in solid form or in the form of emulsions, suspensions or solutions.

In addition to the resin described above, the composition according to the invention may contain various additives, including one or more plasticizers.

Said plasticizers can, for example, be chosen from: polymer plasticizers such as polyphthalates and polyadipates; monomer plasticizers such as azelates, trimellitates (TOTM, TEHTM, etc.), sebacates (DIOS, DINS, DIDS, etc.), adipates (DOA, DEHA, DINA, DIPA, etc.), phthalates (DOP, DEHP, DIDP, DINP, etc.), citrates, benzoates, tallates, glutarates, fumarates, maleates, oleates, palmitates, acetates, for instance acetylated monoglycerides; and mixtures thereof. Phthalates such as dioctyl phthalate, dialkyl adipates such as ditridecyl adipate (DTDA), diacetylated monoglycerides such as glycerol monolaurate diacetate, and dialkyl sebacates, such as diisododecyl sebacate (DIDS), are preferred for use in the present invention. The amount of plasticizer can, for example, represent from 60% to 100% by weight, relative to the weight of the halogenated vinyl polymer.

The composition according to the invention can, moreover, contain:
lubricants, such as stearic acid and esters thereof (including Loxiol® G12 from Cognis), waxy esters (including Loxiol® G70 S from Cognis), polyethylene waxes, paraffin and acrylic lubricants (including the Plastistrengths®, in particular L1000, from Arkema),
inorganic or organic pigments, such as carbon black or titanium dioxide,
thermal and/or UV stabilizers, such as tin stearate, lead stearate, zinc stearate, cadmium stearate, barium stearate or sodium stearate, including Thermolite® from Arkema,
costabilizers, such as epoxidized natural oils, in particular epoxidized soya oils such as Ecepox® PB3 from Arkema,
antioxidants, for example phenolic, sulfur-containing or phosphitic antioxidants,
fillers or reinforcing agents, in particular cellulosic fillers, talc, calcium carbonate, mica or wollastonite, glass or metal oxides or hydrates,
antistatic agents,
fungicides and biocides,
impact modifiers, such as MBS copolymers, including Clearstrength® C303H from Arkema, and acrylic modifiers of core-shell type, such as Durastrength® from Arkema,
swelling agents, such as azodicarbonamides, azobisisobutyronitrile or diethyl azobisisobutyrate,
flame retardants, including antimony trioxide, zinc borate and brominated or chlorinated phosphate esters,
solvents, and
mixtures thereof.

These additives can, for example, represent from 0.1% to 50% of the total weight of the composition.

The composition according to the invention can be used for manufacturing either rigid or plasticized materials. To do this, it can be used by any means, and in particular by calendering, extrusion, extrusion-blow molding, injection molding, rotational molding, thermoforming, etc.

This composition can thus be used for manufacturing coatings, in particular floor and wall coatings, furniture, mesh pieces or parts of the passenger compartment of motor vehicles (such as dashboard, steering wheel and door trim skins); clothing; seals, in particular in construction or the motor vehicle industry; self-adhesive, food, agricultural, stationery films; roofing sheets and panels, and also cladding panels; profiles, in particular shower and window profiles; shutters, doors, skirting boards, angles; cables; and devices for transporting or storing fluids, in particular tubes, sheaths, pumps, valves or connectors; electrical housings; hosepipes; bottles and flasks, sheets, in particular for packaging; stretchable films; blood or solute bags; transfusion tubes; longplaying records; toys; panels; helmets; shoes; hangings, curtains or tablecloths; buoys; gloves; blinds; fibers; glues and adhesives; membranes.

The subject of the invention is therefore also the abovementioned uses.

The invention will be understood more clearly in the light of the following examples, which are given for illustration purposes only and which are not intended to limit the scope of the invention, which is defined by the attached claims.

### EXAMPLES

### Example 1

### Preparation of a PVC Latex

### Example 1a

### Emulsion Synthesis of a PVC Latex (Particle Diameter=200 nm)

10 liters of deionized water are introduced into a 30-liter autoclave equipped with. an anchor-type stirring spindle. 2.2 g of sodium formaldehyde sulfoxylate, 2.2 g of ethylenediaminetetraacetic acid disodium salt and 0.24 g of iron sulfate pentahydrate are added. The autoclave is closed, the stirring is started at 80 rpm and a vacuum is drawn under a pressure of 0.04 bar for 30 minutes. 8 kg of vinyl chloride monomer (VCM) are charged. The temperature of the reaction medium is then brought to 66° C. by heating the autoclave by means of its jacket according to a heating ramp at 2° C./min. When the temperature reaches 66° C., a solution of potassium persulfate in water at 2 g/liter is injected at a flow rate of 270 ml/hour, for 1 hour, and then at 180 ml/hour for 4 hours.

After a period of 30 minutes at the temperature of 66° C., a solution of sodium lauryl sulfate at 80 g/liter is injected at a flow rate of 250 ml/hour for 4 hours. The reaction is continued until a decrease in pressure of −1 bar, relative to the initial VCM pressure, is obtained. At this level of pressure decrease, the autoclave is cooled to 50° C. by injecting water at 18° C. into the jacket. The total reaction time from the end of the heating ramp to −1 bar is approximately 5 hours. The VCM is degassed, at 50° C. with stirring reduced to 50 rpm, and then the autoclave is placed under a dynamic vacuum for 4 hours in order to eliminate the residual VCM. 19.2 kg of latex containing 37.5% of dry extract are thus recovered. The diameter of the elementary particles, measured using a Brookhaven particle sizer, comes to 226 nm.

### Example 1b

### Emulsion Synthesis of a PVC Latex (Particle Diameter=100 nm)

8.8 liters of deionized water, 32 g of lauric acid and 9 g of potassium hydroxide from a solution at 100 g/liter are introduced into a 30-liter autoclave equipped with an anchor-type stirring spindle. 1.1 g of sodium: formaldehyde sulfoxylate, 1 g of ethylene-diaminetetraacetic acid disodium salt and 0.11 g of iron sulfate pentahydrate are added. The autoclave is closed, the stirring is started at 80 rpm and a vacuum is drawn under a pressure of 0.04 bar for 30 mina 8 kg of vinyl chloride monomer (VCM) are charged. The temperature of the reaction medium is brought to 55° C. by heating the autoclave by means of its jacket according to a heating ramp of 2° C./min. When the temperature reaches 55° C., a solution of ammonium persulfate in water at 4 g/liter is injected at a flow rate of 200 ml/hour for 5 hours.

After a period of 30 minutes at the temperature of 55° C., a solution of sodium dodecyl benzene sulfonate at 88 g/liter is injected at a flow rate of 250 ml/hour for 4 hours. The reaction is continued until a decrease in pressure of −1 bar, relative to the initial VCM pressure, is obtained. At this level of pressure decrease, the autoclave is cooled to 40° C. by injecting water at 18° C. into the jacket. The total reaction time from the end of the heating ramp to −1 bar is approximately 5 hours. The VCM is degassed, at 40° C. with stirring reduced to 50 rpm, and then the autoclave is placed under a dynamic vacuum for 4 hours in order to eliminate the residual VCM. 18 kg of latex containing 39.3% of dry extract are thus recovered. The average diameter of the elementary particles, measured using a Brookhaven particle sizer, comes to 115 nm.

### Example 2

### Preparation of a Latex of Copolymer Bearing Associative Groups

10 liters of deionized water are introduced into a 30-liter autoclave equipped with an anchor-type stirring spindle, with a system for reflux condensation of vapors and with lines for introducing the reactants. 2.2 g of sodium formaldehyde sulfoxylate, 2.2 g of ethylenediaminetetraacetic acid disodium salt and 0.24 g of iron sulfate pentahydrate are added. The autoclave is closed, the stirring is started at 80 rpm and the medium is flushed by bubbling nitrogen for 30 minutes. 5.6 kg of methyl methacrylate, 0.48 kg of ethyl ethacrylate, 1.92 kg of Norsocryl N102® from Arkema (mixture of 25% by weight of ethyl methacrylate imidazolidone, MEIO, and of 75% by weight of methyl methacrylate), and 36.5 g of n-dodecyl mercaptan from Arkema are then successively charged. The temperature of the reaction medium is then brought to 70° C. by heating the autoclave by means of its jacket according to a heating ramp at 2° C./min. When the temperature reaches 70° C., a solution of potassium persulfate in water at 2 g/liter is injected at a flow rate of 200 ml/hour for 1 hour, and then at 150 ml/hour for 3 hours.

After 30 minutes at the temperature of 70° C., a solution of sodium lauryl sulfate at 100 g/liter is injected at a flow rate of 250 ml/hour for 3.5 hours. At the end of the addition of the potassium persulfate and of the sodium lauryl sulfate, the reaction is completed by treatment for one hour at 80° C. with stirring. The autoclave is then cooled to 20° C. by injecting water at 18° C. into a jacket. The total reaction time from the end of the heating ramp to the end of the treatment at 80° C. is approximately 5 hours. 18.7 kg of latex containing 38.4% of dry extract are thus recovered. The diameter of the elementary particles, measured using a Brookhaven particle sizer, comes to 235 nm.

### Example 3

### Blending and Spray Drying of the Latices According to the Invention

The latices of Example 1a (or 1b) and of Example 2 are diluted by adding deionized water until a dry extract of 20% is obtained. 15 kg of each of the diluted latices are placed in a 50-liter tank equipped with an anchor stirrer. The latex blend is homogenized with stirring at 50 rpm for 1 hour at ambient temperature. After this homogenization step, the latex blend is filtered through a metal wire mesh with a mesh size of 100 μm.

The latex blend is then dried with a Niro Minor Production spray dryer fitted with a two-fluid nozzle having an internal diameter of 1 mm. The spray-drying operating conditions are set as follows: inlet temperature=150° C., outlet temperature=70° C., spray air pressure=3 bar. Under these conditions, the drying flow rate stabilizes at 14 kg of latex/hour. The spray dryer is operated for 2 hours. 5.5 kg of blend powder are thus obtained. The residual moisture content in the powder is less than 0.5%.

### Example 4

### Blending and Coagulation/Drying of the Latices According to the Invention

The latices of Example 1a (or 1b) and of Example 2 are diluted by adding deionized water until a dry extract of 20% is obtained. 15 kg of each of the dilute latices are placed in a 50-liter tank equipped with an anchor stirrer. The latex blend is homogenized with stirring. at 50 rpm for 1 hour at ambient temperature. After this homogenization step, the latex blend is filtered through a metal wire mesh with a mesh size of 100 μm.

The 30 kg of the latex blend are then introduced into a glass reactor having a volume of 60 liters and an internal diameter of 300 mm, which is equipped with a jacket heated by a thermoregulated bath and with a stirring spindle of 3-bladed propeller type, also called “impeller”, having a diameter of 205 mm. The stirring speed is brought to 600 rpm in successive steps of 100 rpm. 180 ml of 95% concentrated sulfuric acid are added over 5 minutes in order to reduce the pH of the blend to 1. Coagulation of the latex is thus obtained. The coagulated latex is brought to 90° C. for 30 minutes after a heating ramp at 2° C./minutes. At the end of this heating step, the coagulated latex is neutralized by running in a solution of sodium hydroxide at 100 g/liter, and then hot-filtered under a pressure of 5 bar through a polypropylene cloth having an average pore size of 6 μm. The filtrate is washed by adding 10 liters of deionized water, and then dried at 60° C. in a ventilated oven until the weight is constant. 5.9 kg of blend powder are thus obtained. The residual moisture content in the powder is less than 0.5%.

1. A method for preparing a polymer resin, comprising the successive steps consisting in:
1—forming a first latex from at least one halogenated vinyl polymer and a second latex from at least one copolymer containing, firstly, units derived from a first monomer (A) making said copolymer compatible with said halogenated vinyl polymer and, secondly, units derived from a second monomer (B) bearing at least one associative group chosen from imidazolidonyl, triazolyl, triazinyl, bisureyl and ureidopyrimidyl groups, preferably an imidazolidonyl group,
2—blending said latices, and
3—isolating and drying the polymers contained in said latices in order to form a pulverulent resin.

2. The method as claimed in claim 1, wherein the copolymer is capable of being obtained starting from:
firstly, a monomer (A) which is a (meth)acrylic monomer chosen from: methyl methacrylate, (methoxy)polyethylene glycol (meth)acrylate and acrylonitrile; or maleic anhydride,
secondly, a monomer (B) bearing associative groups, preferably imidazolidonyl groups, which is advantageously chosen from: ethylimidazolidone methacrylate (or MEIO) and ethylimidazolidone methacrylamide (or WAM II), and
optionally, one or more other monomers chosen from acrylic or methacrylic acids, esters thereof, amides thereof and salts thereof, itaconic acid, esters thereof, amides thereof or salts thereof, and styrene and derivatives thereof such as 4-styrene sulfonate.

3. The method as claimed in claim 1, wherein said copolymer is capable of being obtained by aqueous-emulsion free-radical polymerization.

4. The method as claimed in claim 1, wherein the halogenated vinyl polymer is chosen from: poly(vinyl chloride) (PVC); copolymers of vinyl chloride with monomers chosen from acrylonitrile, ethylene, propylene or vinyl acetate; poly(vinylidene chloride); and blends thereof.

5. The method as claimed in claim 1, wherein the halogenated vinyl polymer is chosen from fluorinated polymers comprising one or more monomers of formula (I):
CFX═CHX′ (I)
where X and X′ independently denote a hydrogen or halogen (in particular fluorine or chlorine) atom or a perhalogenated (in particular perfluorinated) alkyl radical, with preferably X═F and X′═H.

6. The method as claimed in claim 1, wherein the halogenated vinyl polymer is chosen from:
poly(vinylidene fluoride) (PVDF),
copolymers of vinylidene fluoride with, for example, hexafluoropropylene (HFP), chlorotrifluoroethylene (CTFE), hexafluoropropylene (HFP), trifluoroethylene (VF3) or tetrafluoroethylene (TFE),
homopolymers and copolymers of trifluoroethylene (VF3),
fluoroethylene/propylene (FEP) copolymers,
copolymers of ethylene with fluoroethylene/propylene (FEP), tetrafluoroethylene (TFE), perfluoromethylvinyl ether (PFMVE), chlorotrifluoroethylene (CTFE) or hexafluoropropylene (HFP), and
blends thereof.

7. The method as claimed in claim 1, wherein the halogenated vinyl polymer is capable of being obtained according to an aqueous-microsuspension polymerization method, optionally of seeded type, or an aqueous-emulsion polymerization method.

8. The method as claimed in claim 1, wherein, in the second step of the method, the latices are blended in a ratio of the halogenated vinyl polymer to the copolymer bearing associative groups which ranges from 1:200 to 100:1, more preferably from 1:100 to 1:1 (with respect to dry matter).

9. The method as claimed in claim 1, wherein, in the third step of the method, the latices are subjected to a spray-drying, coagulation or freeze-drying method.

10. A resin which can be obtained according to the method as claimed in claim 1.

11. A composition containing the resin as claimed in claim 10 and, optionally, plasticizers.

12. An item selected from the group consisting of coatings, in particular soil and wall coatings, furniture, mesh pieces or parts of the passenger compartment of motor vehicles (such as dashboard, steering wheel and door trim skins); clothing; seals, in particular in construction or the motor vehicle industry; self-adhesive, food, agricultural, stationery films; roofing sheets and panels, and also cladding panels; profiles, in particular shower and window profiles; shutters, doors, skirting boards, angles; cables; and devices for transporting or storing fluids, in particular tubes, sheaths, pumps, valves or connectors; electrical housings; hosepipes; bottles and flasks, sheets, in particular for packaging; stretchable films; blood or solute bags; transfusion tubes; longplaying records; toys; panels; helmets; shoes; hangings, curtains or tablecloths; buoys; gloves; blinds; fibers; glues and adhesives; membranes, which item is made from the composition as claimed in claim 11.
